(19) United States
(12) Patent Application Publication
(10) Pub. No.: US 2026/0001791 A1
(43) Pub. Date: Jan. 1, 2026

(54) METHOD AND SYSTEM OF REMOVING ENVIRONMENTAL CONTAMINANTS FROM WATER

(71) Applicant: Paul Charles Wegner, San Carlos, CA (US)

(72) Inventor: Paul Charles Wegner, San Carlos, CA (US)

(21) Appl. No.: 19/320,019

(22) Filed: Sep. 5, 2025

Related U.S. Application Data
(62) Division of application No. 17/861,317, filed on Jul. 11, 2022, now Pat. No. 12,428,325.
(60) Provisional application No. 63/220,583, filed on Jul. 12, 2021.

(51) Int. Cl. C02F 1/54; B01D 61/14; B01D 61/16; B01D 61/18; B01D 61/20; C02F 1/44; C02F 101/10; C02F 101/20; C02F 101/36

(52) U.S. Cl. CPC C02F 1/54; B01D 61/149; B01D 61/16; B01D 61/18; B01D 61/20; C02F 1/444; B01D 2311/04; B01D 2311/12; B01D 2311/252; B01D 2311/2642; B01D 2317/025; B01D 2317/08; C02F 2101/105; C02F 2101/203; C02F 2101/36; C02F 2301/043; C02F 2301/046; C02F 2305/00

(57) ABSTRACT

A method and system of removing environmental contaminants from water comprising adding a fatty chemical to form a mixture with the water in which the fatty chemical and the environmental contaminants complex to form molecular complexes. The mixture is then filtered to remove the molecular complexes from the water.

### CROSS-REFERENCE

This application is based on and claims priority to U.S. Provisional Patent Application Ser. No. 63,220,583, filed Jul. 12, 2021, which is incorporated herein in its entirety by reference.

### BACKGROUND OF THE INVENTION

### 1. Field of the Invention

This invention relates generally, but not by way of limitation, to a method and to a system of removing environmental toxins from water.

### 2. Description of the Related Art

Perfluorooctanesulfonic acid (PFOS), perfluorooctanoic acid (PFOA), and other perfluoroalkyl and polyfluoroalkyl substances (collectively, PFAS) have unique chemical properties. These chemicals can often be found in fire control foams, nonstick pans, microwave popcorn bags, stainmaster carpet, scotch guard, and many other industrial products. The molecules of these chemicals have polar heads, hydrophobic tails, and do not readily degrade in the environment. They are easily spread in the environment and are, therefore, increasingly pervasive in our water sources. These molecules can even be found in rainwater.

Unfortunately, these chemicals are also extremely toxic. When dispersed in water, these chemicals can have harmful effects even when the concentration is measured in parts per trillion (ppt). These chemicals tend to biomagnify in the environment and accumulate in humans. This accumulation has been shown to cause kidney and pancreatic cancer. Accordingly, the U.S. Environmental Protection Agency desires to reduce PFOS, PFOA, and certain other PFAS to concentrations of less than one ppt in drinking water. As a result, it is desirable to remove these toxins from water.

The prior art related to PFAS removal consists of adsorption of the contaminate onto a solid or having the PFAS precipitate as a solid. These methods fail to reduce the PFAS quantities in the water to the desired level. Further, these methods have a low loading capacity. This means that the amount of PFAS actively filtered is relatively low compared to the physical resources necessary to perform the filtering. The loading capacity of these methods is critically important because the concentrated waste is either placed in a landfill, or more preferably, incinerated. Incineration is the preferred method of disposal because it destroys the toxins. However, if the loading capacity of the filtration method is low, the energy required to incinerate the concentrated waste is inefficiently high.

Lastly, all of these aforementioned methods lack in selectivity of the toxins being filtered. In other words, each method may filter many other types of toxins which even further reduces the loading capacity with respect to PFAS.

By way of example, ion exchange and activated carbon have excellent initial performance at filtering toxins. However, once the outer surface of these filters is loaded with PFAS, the resin is exhausted and very little of the inner surface of the resin is used. As can be seen, these methods result in a low loading capacity and a high toxin leakage. To make matters worse, carbon has very poor selectivity and quickly becomes saturated with other contaminants. Ion exchange has slightly better selectivity but still collects other contaminants thereby reducing its ability to effectively filter PFAS to the desired levels. Lastly, membranes generate a high volume of concentrated waste that is economically impractical to destroy.

None of the above approaches focus on absorbing the unique hydrophobic tail of PFAS to form molecular complexes with fatty chemicals that remain in a highly dispersed state. This unique property allows for the removal of PFAS from water, while producing a concentrated molecular complex. Maintaining a highly dispersed molecular complex allows for rapid and complete complexation with PFAS.

Therefore, it is desirable to develop a method and a system of removing PFAS from water with a high loading capacity, minimal required fuel for incineration of the concentrated waste, a high level of selectivity, and the ability to filter these toxins to a concentration measured in ppt.

### SUMMARY OF THE INVENTION

The present invention relates to a method and a system of removing environmental contaminants from water. In one embodiment, the invention relates to a method of removing environmental contaminants from water comprising: adding a fatty chemical to form a mixture with the water in which the fatty chemical and the environmental contaminants complex to form molecular complexes. The mixture is then filtered to remove the molecular complexes from the water.

The fatty chemical may be at least one of trimethylstearylamine (TMSA); trimethylbehenylamine (TMBA); steryl choline; stearyl guanidine derivative, stearyl argininate esters; creatinine; and guanidine derivatives containing C12 to C22 hydrocarbon chains.

The filter may be of the type of at least one of crossflow, hollow fiber, or membranes with a micro- to ultra-filtration pore size.

The method may further comprise destruction of the PFAS removed from the water. The method of destruction may use steam plasma torch, incineration, or smoldering technology.

The environmental contaminants may be PFAS.

At least a portion of the mixture rejected by the filter may be recirculated with the feedwater to reduce the concentration of contaminants in the rejected water. At least another portion of the mixture rejected by the filter is filtered by a second filter to produce a waste containing the environmental contaminants removed from the feedwater.

Optionally, the method of removing environmental contaminants from water may include an optional step where the source of feedwater is filtered to remove phosphate, iron, and other transition metals prior to mixing with the fatty chemical.

### BRIEF DESCRIPTION OF THE DRAWINGS

FIG. 1 is a flowchart showing the step-by-step process of one preferred embodiment of the present invention.

FIG. 2 is a flowchart showing the step-by-step process of a second preferred embodiment of the present invention.

### DETAILED DESCRIPTION OF THE INVENTION

The embodiments discussed herein are merely illustrative of specific manners in which to make and use the invention and are not to be interpreted as limiting the scope.

While the invention has been described with a certain degree of particularity, it is to be noted that many modifications may be made in the details of the invention's construction and the arrangement of its components without departing from the scope of this disclosure. It is understood that the invention is not limited to the embodiments set forth herein for purposes of exemplification.

The present invention relates to a method and a system of removing PFAS and other toxins from water. The PFAS may be, but are not limited to, PFOS or PFOA which are extremely toxic and increasingly prevalent in our environment. These toxins form water soluble complexes with a broad spectrum of inorganic chemicals such as sodium, calcium, and magnesium; a host of transition metals; and a broad spectrum of organic chemicals such as amines and amino acids. This makes selective removal very difficult. Removing these chemicals to concentrations lower than one ppt requires use of chemicals which produce a water insoluble and chemically stable molecular complex that has a very large surface area to maximize removal speed and thoroughness. Additionally, it is desirable to use chemicals that are nontoxic.

The method comprises addition of a dispersible fatty chemical to the water. PFAS consist of non-polar, hydrophobic tails and very polar heads. In this case, the hydrophobic tails and polar heads form a molecular complex with the hydrophobic fatty chains and polar cationic head of the dispersible fatty chemical. Gathered in this way, these water insoluble molecular clusters are formed by the hydrophobic and polar head portions of the chemicals and water is generally pushed out of these clusters. These clusters form molecular complexes containing PFAS that are generally large enough to be removed from the water stream with a micro- to ultra-filtration pore size. Consequently, the filtered complex results in a permeate with lower concentrations of PFAS.

After the dispersible fatty chemical is added to a feedwater stream of the water, the stream may be mixed in a mixing tank. Mixing the stream in a mixing tank allows for the complex of TMSA and PFAS to form prior to reaching the filters. Otherwise, the molecular complexes may blind the filter inside the pores of membrane. Further, the present invention departs from known prior art by not adsorbing the contaminate onto a solid or forming solid particles or precipitations during the PFAS removal process. Consequently, the process allows for rapid and thorough removal without blinding or clogging the filters.

Due to the high loading capacity of fatty soaps, one can remove PFAS to very low concentration levels while producing a low volume of hazardous waste which may be destroyed with a variety of methods that include—but are not limited to—plasma torch, incineration, or smoldering technology. The resulting liquid and gases may then be returned to the feedwater to remove any traces of PFAS that were not destroyed.

A significant benefit to returning the resulting liquid and gases to the feedwater is that the fatty chemicals used in previous cycles can be returned and reused. Consequently, the fatty chemical content within the loop continuously builds up to higher concentrations. The increased concentration leads to an increased effectiveness in removing toxins without requiring more additives.

Additionally, PFAS require a high level of efficiency when being incinerated. A high level of incineration efficiency requires a significant amount of fuel. By returning the liquid and gases leftover from the incineration process to the feedwater, any remaining PFAS may be returned to the feedwater to be filtered again. This allows for a lower efficiency requirement in the incineration process and lower fuel consumption.

Polar amines such as TMSA or TMBA are useful complexing agents. They form water insoluble complexes with PFAS. The shorter C18 fatty amine, TMSA, is more easily dispersed in water than TMBA leading to faster PFAS complexing, while the longer C22 fatty amine, TMBA, forms larger molecular complex clusters that are easier to filter out.

Other analogs to TMSA and TMBA include stearyl choline, stearyl guanidine derivative, stearyl argininate esters, creatinine, and guanidine derivatives containing C12 to C22 hydrocarbon chains. In the broadest sense, the complexing agent comprises a polar head and a hydrophobic tail. Optionally, in order to remove most substances (such as phosphate, iron, and other transition metals) that may compete with PFAS during the TMSA/TMBA complexing process, the feedwater may be filtered using a crossflow filter prior to adding TMSA/TMBA to the water stream.

The filters utilized by the present invention may be micro- to ultra-filtration pore size, which allows one to filter out all the molecular complexes and naturally occurring suspended solids while still allowing most water-soluble chemicals to pass freely. Crossflow filters are preferred, but hollow fiber and membranes are acceptable.

The concentrated toxic waste may be destroyed in any reasonable manner. Examples of acceptable destruction methods include steam plasma torch, incineration, and smoldering technology. Since all the resulting waste water and gases may be returned to the feedwater for reprocessing, complete destruction of PFAS is not critical.

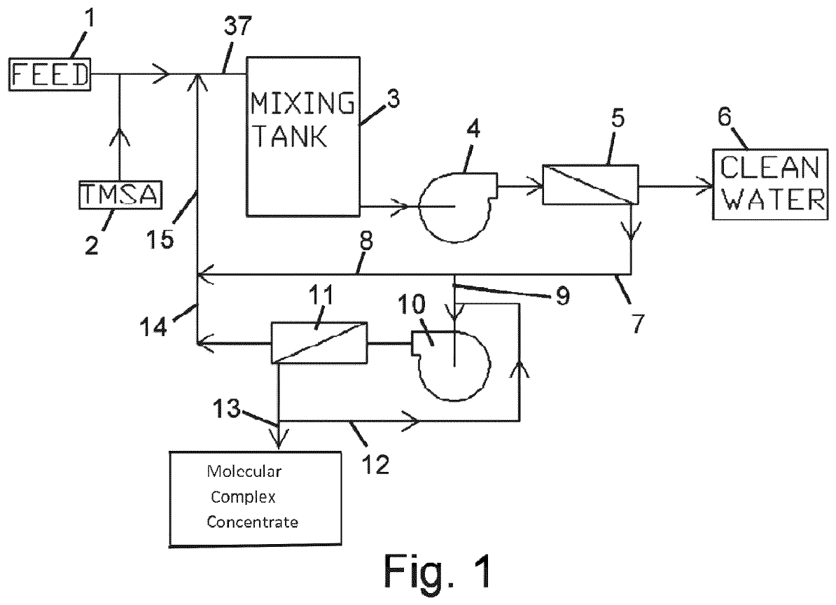

Referring to the drawings in detail, FIG. 1 illustrates the step-by-step process of one preferred embodiment of the claimed method for removing PFAS from water. The first step comprises adding TMSA 2 to feedwater 1 prior to the stream entering a mixing tank 3. In one non-limiting example, the TMSA concentration is roughly 10 ppm and the reaction time of the mixing tank is roughly 10 minutes. The water from the mixing tank 3 is pumped by a pump 4 through the first filter 5. The permeate of the first filter 5 is a clean water stream 6 from which the PFAS have largely been removed. The stream rejected by the first filter 5 is fed back into the mixing tank 3. A portion of the stream rejected by the first filter 5 is bled off and pumped by a pump 10 through a second filter 11. The permeate of the second filter 11 is returned to the mixing tank 3 and the reject stream is returned to the suction side of pump 10. A portion of the stream rejected by the second filter 11 is bled off as PFAS molecular complex concentrate 13. The PFAS molecular complex concentrate 13 may then be destroyed in any reasonable manner.

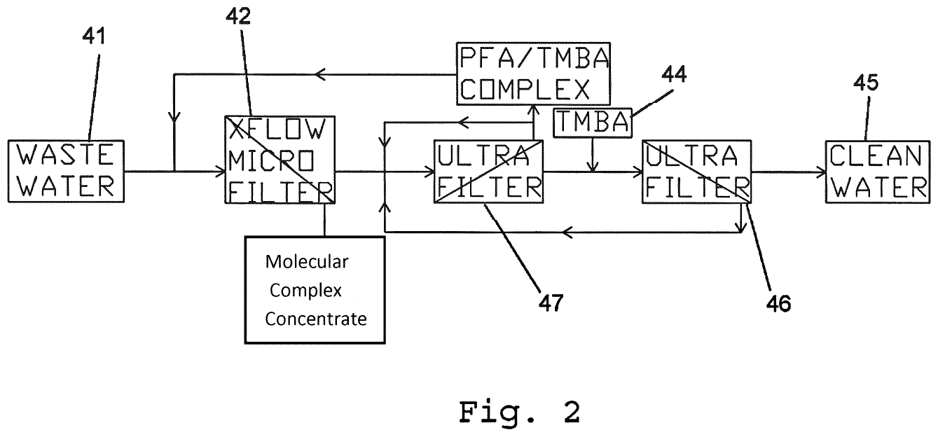

FIG. 2 illustrates the step-by-step process of a second preferred embodiment of the claimed method for removing PFAS from water. The first step comprises running the feedwater 41 through a crossflow filter 42 to remove phosphate, iron, and other transition metals which may compete with PFAS during the TMBA/TMSA complexing process. The permeate of the crossflow filter is fed into a first ultra-filter 47 before TMBA 44 is added to the stream. After TMBA is added to the stream, the stream is passed through a second ultra-filter 46. The permeate of the second ultra-filter is a clean water stream 45. The rejected stream of the second ultra-filter is fed back into the first ultra-filter 47. The rejected stream of the first ultra-filter is fed into the crossflow filter 42 while a portion is fed back into the first ultra-filter 47. The rejected stream of the crossflow filter 42 is bled off as PFAS molecular complex concentrate 48.

Whereas, the invention has been described in relation to the drawings attached hereto, it should be understood that other and further modifications, apart from those shown or suggested herein, may be made within the scope of this invention.

What is claimed is:

1. A system of removing environmental contaminants from water comprising:
a source of feedwater having environmental contaminants therein;
a fatty chemical;
a mixing tank wherein the feedwater and the fatty chemical are mixed together to form a mixture such that the environmental contaminates and the fatty chemical complex to form molecular complexes; and
a filter in fluid communication with the mixing tank that removes the molecular complexes from the mixture.

2. The method of removing environmental contaminants from water of claim 1 where the fatty chemical is selected from the group consisting of: trimethylstearylamine; trimethylbehenylamine; steryl choline; stearyl guanidine derivative, stearyl argininate esters; creatinine; and guanidine derivatives containing C12 to C22 hydrocarbon chains.

3. The method of removing environmental contaminants from water of claim 1 where the environmental contaminants removed from the water are at least one of perfluorooctanesulfonic acid, perfluorooctanoic acid, or other perfluoroalkyl and polyfluoroalkyl substances.
